(19) United States
(12) Patent Application Publication
(10) Pub. No.: US 2014/0334435 A1
(43) Pub. Date: Nov. 13, 2014

(54) Systems and Methods for Scalable Device-to-Device Discovery via Device Grouping

(71) Applicant: Futurewei Technologies, Inc., Plano, TX (US)

(72) Inventor: Mazin Al-Shalash, Frisco, TX (US)

(73) Assignee: Futurewei Technologies, Inc., Plano, TX (US)

(21) Appl. No.: 14/274,693

(22) Filed: May 10, 2014

Related U.S. Application Data
(60) Provisional application No. 61/822,200, filed on May 10, 2013.

(51) Int. Cl. H04W 8/00; H04L 5/00

(52) U.S. Cl. CPC H04W 8/005; H04L 5/003
USPC 370/330

(57) ABSTRACT

System and method embodiments are provided to select and organize devices in a wireless network for allowing efficient transmission of discovery signals. In an embodiment, a network controller for grouping devices for device-to-device (D2D) discovery allocates a plurality of transmission opportunities for D2D discovery in a wireless network. Each one of the transmission opportunities defines at least one of a time slot and a frequency for transmitting a discovery subframe for D2D discovery. The network controller further groups, via signaling, a plurality of devices in the wireless network into a plurality of groups, wherein the devices in each group are in close proximity to each other. The network controller then assigns a corresponding transmission opportunity of the allocated transmission opportunities to each group.

This application claims the benefit of U.S. Provisional Application No. 61/822,200 filed on May 10, 2013 by Mazin Al-Shalash and entitled “System and Method for Scalable Device-to-Device Discovery via Device Grouping,” which is hereby incorporated herein by reference as if reproduced in its entirety.

### TECHNICAL FIELD

The present invention relates to the field of wireless network communications, and, in particular embodiments, to systems and methods for scalable device-to-device discovery via device grouping.

### BACKGROUND

Proximity discovery and device-to-device (D2D) communication are receiving increased interest within the wireless communication research and standards community. D2D communication is a promising approach to significantly increase system capacity, by offloading local communications from the base station, and enabling local spectral reuse and future multi-hop and mesh system architectures. Proximity discovery can be seen as an important step towards enabling D2D communications, as it is necessary to first identify proximate devices that are good candidates for communication. In addition, proximity discovery is seen as a potential enabler for a range of new and innovative proximity services, such as enhanced social networking, enhanced location services, and other applications. One of the challenges to delivering proximity services is to develop a cost effective and scalable solution for device discovery.

### SUMMARY OF THE INVENTION

In accordance with an embodiment, a method performed by a network controller for grouping devices for device-to-device (D2D) discovery includes allocating a plurality of transmission opportunities for D2D discovery in a wireless network. Each one of the transmission opportunities defines at least one of a time slot and a frequency for transmitting a discovery subframe for D2D discovery. The method further includes grouping, via signaling, a plurality of devices in the wireless network into a plurality of groups. The devices in each group of the groups are in close proximity to each other. A corresponding transmission opportunity of the allocated transmission opportunities is then assigned to each group.

In accordance with another embodiment, a network controller providing device grouping for D2D discovery comprises at least one processor and a non-transitory computer readable storage medium storing programming for execution by the at least one processor. The programming includes instructions to allocate a plurality of transmission opportunities for D2D discovery in a wireless network, wherein each one of the transmission opportunities defines at least one of a time slot and a frequency for transmitting a discovery subframe for D2D discovery. The programming includes further instructions to group, via signaling, a plurality of devices in the wireless network into a plurality of groups, wherein the devices in each group of the groups being in close proximity to each other. The network controller is also configured to assign to each group a corresponding transmission opportunity of the allocated transmission opportunities.

In accordance with another embodiment, a method performed by a user device for enabling device grouping for D2D discovery includes receiving, from a network controller, scheduling information for a discovery subframe. The discovery subframe defines at least one of a time slot and a frequency for transmitting a discovery signal. The method also includes receiving, from the network controller, an identity of a group beacon device and scheduling information for a group beacon discovery subframe. The group beacon discovery subframe defines at least one of a second time slot and a second frequency for transmitting a beacon signal by the group beacon device. The user device then performs one of transmitting and listening to the discovery signal in the discovery subframe according to the scheduling information for the group beacon discovery subframe. The user device further performs one of transmitting and listening to the beacon signal in the group beacon discovery subframe according to the identity of the group beacon device and the scheduling information for the group beacon discovery subframe.

In accordance with yet another embodiment, a user device supporting device grouping for D2D comprising at least one processor and a computer readable storage medium storing programming for execution by the at least one processor. The programming includes instructions to receive, from a network controller, scheduling information for a discovery subframe. The discovery subframe defines at least one of a time slot and a frequency for transmitting a discovery signal. The programming includes further instructions to receive, from the network controller, an identity of a group beacon device and scheduling information for a group beacon discovery subframe. The group beacon discovery subframe defines at least one of a second time slot and a second frequency for transmitting a beacon signal by the group beacon device. The user device is configured to perform one of transmitting and listening to the discovery signal in the discovery subframe according to the scheduling information for the group beacon discovery subframe. The user device is further configured to perform one of transmitting and listening to the beacon signal in the group beacon discovery subframe according to the identity of the group beacon device and the scheduling information for the group beacon discovery subframe.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a diagram that illustrates a frame structure of a wireless system utilizing Orthogonal Frequency-Division Multiple Access (OFDMA);

FIG. 2 is a diagram that illustrates a frame structure of a wireless system, including discovery subframes;

FIG. 3 is a diagram that illustrates grouping of devices into discovery groups, and the transmission of discovery signals from devices in a discovery group;

FIG. 4 is a diagram that illustrates a frame structure of a wireless system, including discovery subframes and group beacon discovery subframes according to an embodiment of the disclosure;

FIG. 5 is a diagram that illustrates the transmission of discovery signals by a plurality of group beacon devices according to an embodiment of the disclosure;

FIG. 6 is a diagram that illustrates each of a plurality of devices using a different resource block for discovery;

FIG. 7 is a diagram that illustrates a plurality of devices measuring and reporting discovery group beacons to an eNB according to an embodiment of the disclosure;

FIG. 8 is a message flow for group beacon scheduling and maintenance according to an embodiment of the disclosure;

FIG. 9 is a message flow for no-beacon discovery and measurement reporting according to an embodiment of the disclosure; and

FIG. 10 is a diagram of a processing system that can be used to implement various embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

In device-to-device (D2D) discovery, each device has a signature or discovery message that it can broadcast over the air. The transmissions of discovery signals can be done in designated time/frequency resources, specifically allocated for device discovery. Other devices may listen for these discovery signatures or messages, and upon receiving them, decode them to identify each transmitting device in proximity. As used herein, the term device may refer to a mobile device, fixed device, user equipment (UE), or any other device with wireless communication capability. These terms may be used interchangeably in the description of the invention.

One issue for the design and performance of the discovery process is how to differentiate one discovered device from another, while at the same time protecting the identity of the discovered device and its owner from unauthorized discovery. Another issue is how to avoid potential collisions and interference between the discovery signals transmitted by different devices. By limiting collisions and minimizing interference, the system can maximize the number of proximate devices that can be discovered, for a given allocation of radio resources. Minimizing the radio resources allocated for discovery means that the impact of proximity discovery on system capacity can be minimized. Another issue for the discovery process is how to minimize the impact of the near-far effect, or radio frequency (RF) blocking, on the discovery success rate and discovery range. Additionally, there is a need to minimize the potential interference from proximity services (both discovery signal and D2D communication) to existing non-D2D network nodes that share a single radio frequency carrier.

Minimizing the impact of RF blocking is important as the density of devices grows. Radio signal strength typically falls off exponentially with distance (with an exponent typically between 2 to 4). The received signal strength of two discovery signals received by a discovering device, and transmitted from two different devices at different distances from the discovering device, can differ by several orders of magnitude. Since any receiver has a limited dynamic range, the discovery signal from a substantially close device can completely swamp a proximate receiver, thereby drowning out signals from more distant devices. This can occur, even though each device may be transmitting their discovery signal on a different frequency resource. In extreme cases, it may only be possible to hear the closest device, from potentially tens or even hundreds of devices transmitting discovery signals in the same time slot. Thus, addressing the near far problem is important to enable efficient and scalable proximity device discovery.

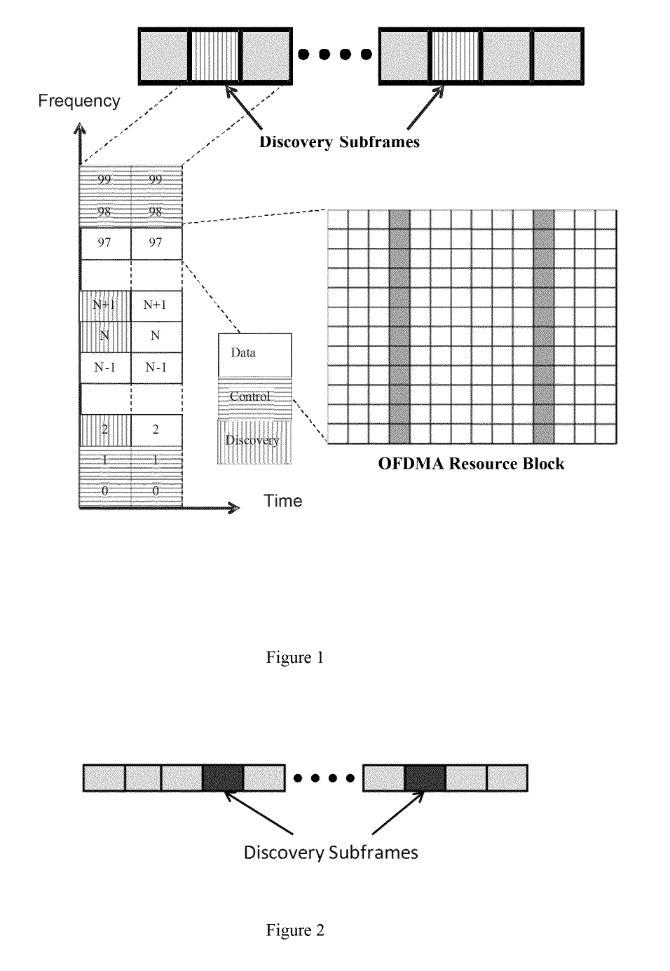

FIG. 1 shows a discovery subframe using Orthogonal Frequency Division Multiple Access (OFDMA) in a wireless system such as Long Term Evolution (LTE) or LTE-advanced. Each subframe comprises a number of resource blocks numbered 0 through 99, for example. A resource block comprises a number of OFDMA symbols, and each OFDMA symbol comprises a number of subcarriers of resource elements. The resource blocks may be designated to carry control signaling, data, or discovery signals. The designation of resource blocks for each of these functions may be done statically, semi-statically, or dynamically, and may be indicated to the devices in the network by a fixed node (or nodes) such as a base station, evolved node-B (eNB) in LTE, or access point (AP) in wireless local area networks (WLANs). This indication may be done through messages carried by higher layer signaling, or by physical layer control channels. A discovery subframe comprises resource blocks designated for discovery, and may also include resource blocks designated for control or to carry user data. A non-discovery subframe may only comprise resource blocks for control and user data.

The resource blocks designated for discovery in a discovery subframe may be indicated via a bit map or other encoding method. Alternatively, the designated resource blocks designated for control and or user data in a discovery subframe may be indicated to the device by a bit map or other encoding method. As such, the resource blocks designated for discovery may be implicitly understood to comprise all other resource blocks in the subframe that have not been designated for control or to carry user data. In another implementation, the discovery subframes may occur periodically, and the identity of discovery subframes may be indicated by a frequency parameter and an offset parameter. In yet another scheme, the number and identity of resource blocks designated for control signaling may be different for discovery subframes and non-discovery subframes. This information may be indicated to devices via messaging carried by upper layer signaling of by physical layer control channels.

System and method embodiments are provided herein to select and organize which devices transmit discovery signals in the discovery subframe. A scalable scheme is provided based on grouping transmitting devices together, so that devices transmitting their discovery signals in the same discovery subframe are physically close to each other. Devices in the network can be grouped into discovery groups, e.g., of about equal size, where the devices in one group are geographically close to each other. Each discovery group is allocated certain transmission opportunities, e.g., time slots and/or frequency resources, by the system. A subset of the devices in each group can transmit their discovery signals within the allocated transmission opportunities. Each of the transmitting devices in the subset transmits its discovery signal in a different frequency resource. The grouping provides several advantages, including scalability, reducing the impact of the RF blocking, and better management of interference from discovery signals.

If the discovery signals are received at largely different power levels, the strongest signal can saturate the receiver's dynamic range, and block the decoding of weaker discovery signals. This RF blocking effect can severely limit the number of transmitting devices that can be discovered in a single transmission opportunity. This issue is resolved by grouping the devices in close proximity together. Grouping devices that transmit discovery signals together can ensure that a distant discovering device experiences similar path loss from each of the transmitting devices. This in turn means that the received signals are relatively close to each other in signal strength, thereby reducing the dynamic range of signals received by the discovering device. This also minimizes the impact of RF blocking. The impact further decreases the farther the receiving device is from the transmitting discovery group. The result is an increase in the discovery success rate, as no received signal is strong enough to block reception of the remaining discovery signals. Thus, a distant device is able to discover all the devices transmitting in the group, assuming each transmits its discovery signal in a different frequency resource.

To achieve enhanced discovery via device grouping, a subset of the devices in the group transmit their discovery signals at predefined time slots. These time slots are referred to as discovery subframes, as shown in FIG. 2. Devices that are not transmitting in a particular discovery subframe are in listening mode, and as such try to decode the discovery signals of the transmitting devices. Correct decoding leads to discovery of the transmitting device by a receiving device.

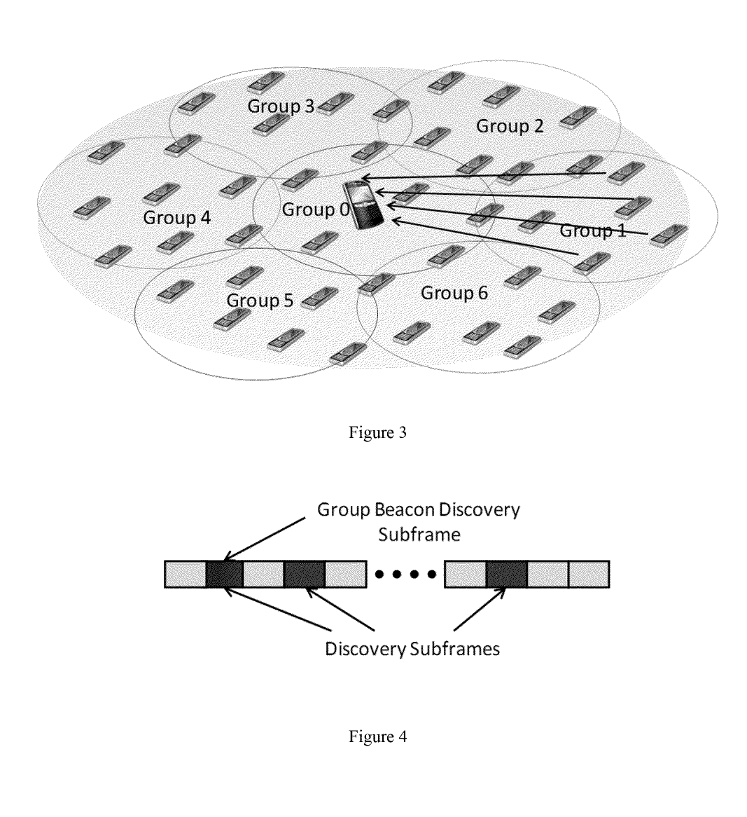

FIG. 3 shows an embodiment of grouping devices into discovery groups, and the transmission of discovery signals from devices in a discovery group. In this example, there are 7 device discovery groups, labeled 0 to 6. The devices in group 1 are transmitting discovery signals in a corresponding discovery subframe. A distant device (in this case illustrated as belonging to discovery group 0) receives their discovery signals at about equal signal strength.

Since the number of users increases in proportion to the square of the distance, more potential discovering users are relatively far from the transmitting group of devices, and can benefit from this approach. A relatively small number of devices can be relatively close to the transmitting group, and still suffer from RF blocking due to the near-far-effect. The performance of proximity discovery for users near to the transmitting group is similar to the performance expected if the devices transmitting discovery signals were selected at random from among all devices (without grouping). Thus, the discovery success rate increases with distance from the transmitting group, up to the limits of the range of the discovery signal.

By forming tighter discovery groups, the proximity discovery problem can be scaled as the density of devices increases. The transmissions from distant discovery groups have relatively low impact on each other, and hence transmission opportunities can be reused by sufficiently distant groups, enhancing the scalability of the solution.

In an embodiment, the devices can be grouped into the discovery groups by associating themselves with designated devices for grouping. Such grouping devices are referred to herein as discovery group beacons. The network selects appropriate devices to serve as group beacons, and adds, removes, replaces, and otherwise manages the selection of the group beacons to achieve the desired scalability.

The group beacons are assigned (non-colliding) radio resources in which they transmit their discovery signals in designated discovery subframes defined as group beacon discovery subframes. FIG. 4 shows an embodiment frame structure including discovery subframes and group beacon discovery subframes. The group beacon discovery subframes correspond to a subset of all discovery subframes.

In an embodiment, the wireless network selects a subset of devices to act as discovery beacons. Each beacon forms the “center” of a discovery group. Discovery group beacons (DGBs) broadcast their discovery signals as specially designated discovery subframes called group beacon (GB) subframes (as shown in FIG. 4). A discovery coordination function broadcasts the schedule for the GB subframes, and the allocated resources within the GB subframe allocated to each DGB. The coordination function is provided by fixed network nodes, such as an eNB or AP. The GB schedule is broadcast by the eNB as part of the system information. This enables all devices, including those without active connections to the wireless network (idle devices), to obtain the discovery schedule for the group beacons.

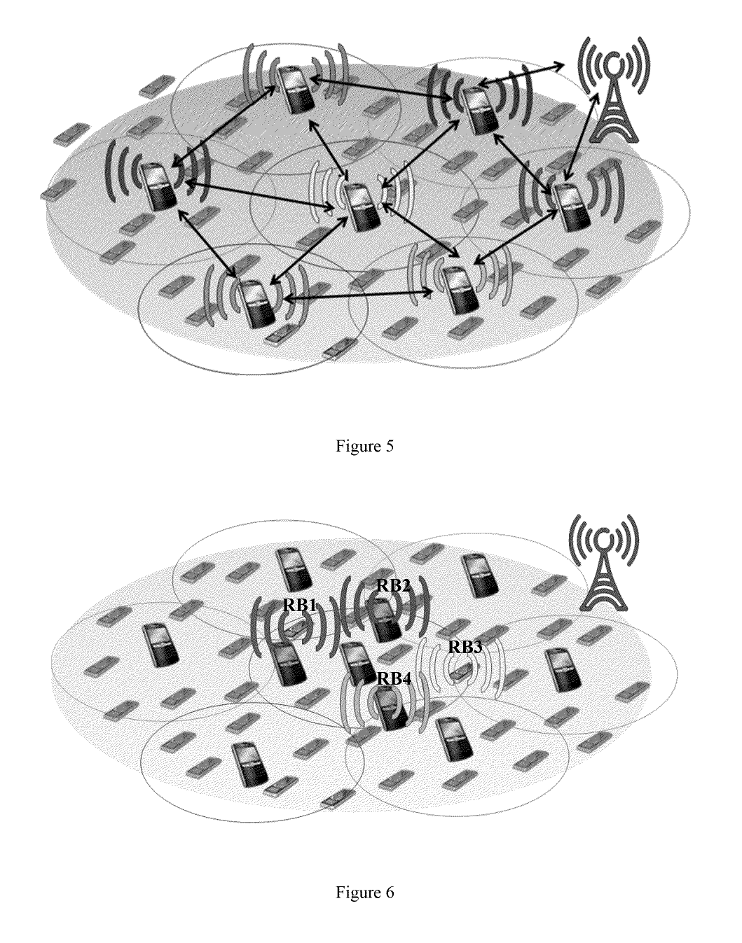

FIG. 5 illustrates the transmission of discover signals by group beacons. The schedule for the transmission of beacon discovery signals is broadcast to all devices, so that non-beacon devices can detect and monitor their surrounding group beacons. Non-beacon devices listen for these periodic transmissions of the discovery signals from the group beacon devices. Based on measurements of the discovery signals from the group beacons, non-beacon devices select and associated with the “best beacon” and its corresponding group. The best beacon may be selected based on a number of criteria, including for example, the geographically closest beacon if the beacon device's proximity can be ascertained independently of the received signal strength (e.g., estimating propagation delay to the device beacon), the beacon with the strongest received signal, the beacon with lowest path loss (requires beacon power to be broadcast), or other suitable criteria. A device's discovery group may change as it moves through the coverage area of the network, since it may detect a stronger or closer beacon, and change its discovery group accordingly.

Another advantage of grouping the devices is that the efficiency of the discovery process increases with the number of discovery groups, since the near-far effect is more localized with the smaller the geographic extent of the transmitting group. This may also lead to increased discovery times, as a larger number of discovery groups may require more discovery subframes to transmit their discovery signals. Since any signal has a certain transmission range, substantially distant discovery groups can share the same time slot without causing significant interference to each other. Thus, it is beneficial to coordinate the transmission of discovery signals, both within and also among groups. The goal of this coordination is to guarantee that only one group within a reuse distance transmits within a designated discovery time slot, and also to minimize collisions between discovery signals transmitted by devices within a single discovery group.

In an embodiment, the eNB allocates subframes for discovery, and schedules one or more discovery group to transmit in each discovery subframe. Each discovery subframe comprises time and/or frequency resources referred to herein as transmission opportunities (TXOPs). A transmission opportunity may comprise a single resource blocks, a number of resource blocks, part of a resource block, or parts of several resource blocks. Since all devices belonging to a single discovery group are by definition in proximity to the group's beacon device, this guarantees the desired grouping behavior for the transmission of discovery signals by non-beacon devices. By controlling the scheduling of discovery group discovery subframes associated with different group beacons, the network can guarantee a minimal geographical separation between different discovery groups transmitting in the same time slot, and thereby limit interference between different discovery groups. The separation between discovery groups sharing the same discovery subframe can be selected to be at least twice the range of the discovery signal.

In an embodiment, not all the devices in a discovery group transmit a discovery signal in every discovery subframe schedule for that group. The system may define a subset of the devices belonging to a designated discovery group to transmit in a designated time slot. Each device transmitting its discovery signal from the group can have a unique radio resource (e.g., frequency domain resource block) or signature (e.g., spreading code), so that collisions between the discovery signals of different devices is minimized. FIG. 6 shows each device in a group using a different resource block for discovery (labeled RB1 to RB4). This allows the discovery signal of each device to be separated from the signals transmitted by other devices and independently decoded, thus maximizing the discovery success rate. The specifics of how to allocate or select transmission resources for each device within a discovery group is beyond the scope of the current disclosure.

As described above, the system selects which devices to serve as discovery group beacons (DGB). The selection of group beacons needs to achieve two objectives. First, every non-beacon device needs to be able to detect at least one group beacon device in its vicinity. Second, the number of devices transmitting discovery signals in each discovery subframe should be about or roughly the same.

The first objective implies that group beacons are to be uniformly distributed throughout the coverage area of the network. In order to achieve this, the system may select beacon devices at various distances from a given eNB, ranging from close to the vicinity of the eNB to near the edge of the eNB's coverage. Furthermore, if the group beacons are uniformly distributed throughout the coverage area, the distances from one group beacon to its neighboring beacons need to be about equal. For example, if the beacon devices were distributed on a uniform hexagonal grid, then each beacon device would have 6 nearest neighbors, each at the same distance.

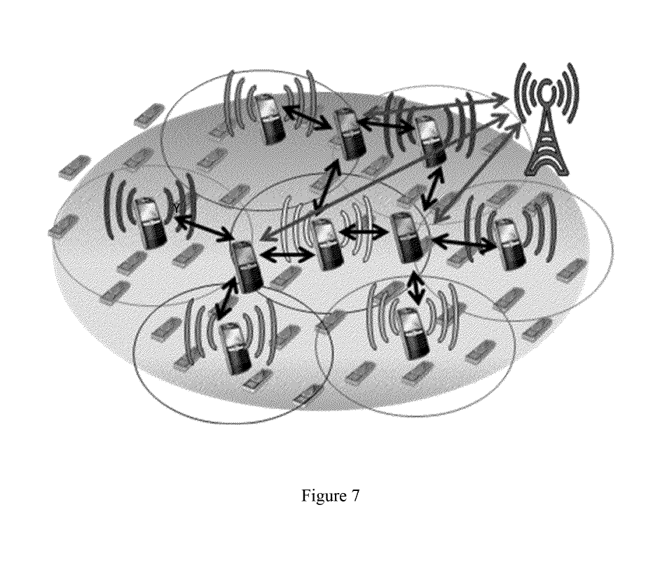

FIG. 7 shows an embodiment of a plurality of devices measuring and reporting discovery group beacons to an eNB. The network can make use of measurements reported by the devices to select the best set of devices to configure as group beacons. For example, in an embodiment, a device may estimate its distance (propagation delay) to each beacon device in its proximity, and report to the network the distances to the beacon devices. Alternatively, the device may report other measurements from which the distance may be inferred, such as beacon signal strength or path loss of each beacon. The network may then decide that a particular device is a good candidate to serve as a group beacon, for instance if it is at about equal distance from a set of existing group beacons (e.g., 6 group beacons). In an embodiment, the variance of estimated distance to a set of beacon devices may serve as an indicator to the suitability of a device to be selected as another group beacon.

As the device's location normally changes due to mobility, a device previously selected to be a group beacon, may after some time no longer be in the best location for this function. For example, the group beacon may have moved closer to some subset of its neighboring beacons, and away from other beacons. The system may hence decide that a second device is in a better location to serve as the beacon for this discovery group. The network may then signal the first device to cease transmission of the group beacon discovery signal, and signal the second device to start transmission of the group beacon discovery signal, thus replacing the first DGB device with the newly selected device.

In another embodiment, the network may decide to split a discovery group into two or more discovery groups. In this case, the original group beacon may continue to transmit the group discovery signal, while the network signals one or more additional devices to start transmitting group discovery signals. Furthermore, the network may, at some time, determine that there are too many group beacons in close proximity to each other. The network may hence signal one or more of these beacon devices to stop transmitting the beacon discovery signal, thereby reducing the number of discovery beacons, and consequently the number of discovery groups in a particular area.

Each time the network changes the selection of DGBs, non-beacon devices in the vicinity may need to change their group association. For example, if a new discovery beacon appears which is closer or stronger than the beacon for the device's current discovery group, then the device may associate with the discovery group identified by this group beacon. Alternatively, if the device's current DGB stops transmitting its discovery signal, then the device needs to select an alternative beacon device and associate with the corresponding discovery group.

In an embodiment, the network may decide to select stationary or slowly moving devices as DGBs. By imposing this restriction, the selection of DGBs may stay unchanged over a relatively long period of time, thereby minimizing the need for non-beacon devices to associate with a different discovery group. This would also minimize network signaling needed to create new DGBs, or remove existing DGBs. In an embodiment, the rate of event triggered beacon measurements may be used by the network as an indication of the relative mobility of the reporting device compared to other devices.

In each of the use cases described above, devices may only need to report their locations relative to surrounding group beacons (or measurements from which the relative locations may be inferred) to the network. In another embodiment, the network may obtain the absolute location of connected devices, and create a map of these devices. A subset of these devices can then be selected directly to serve as DGBs. Various methods to obtain device localization (location information) already exist, and are currently used to support location based services (LBS). As such, the specific methodology to obtain the absolute location of a device may be different based on device capabilities and operator preference.

In some scenarios, a device may not be able to detect any DGB at its location. In this case, the first objective described above for selection of group beacons is not satisfied. In an embodiment, if a device cannot detect the discovery signal for any DGB in the beacon discovery frame, it reports this event to the network. The network may then select a new device to serve as a DGB in that vicinity. This new DGB may be the same device that reported to the network, or may be a different device.

Regarding the second objective for selection of group beacons, the device density may vary significantly from one location to another. Hence, with a uniform distribution of group beacons, some groups may contain a large number of devices (if the device density is substantially high in that vicinity), while other groups may comprise a relatively low numbers of devices (if the density of devices in that vicinity is relatively sparse). Various approaches may be used in order to achieve the second objective of equal discovery signal transmission per discovery subframe. In one approach, the system may schedule more frequent discovery subframes for larger discovery groups. If, for example, the number of discovery subframes allocated to a specific discovery group is proportional to the number of devices forming that discovery group, then the number of devices transmitting their discovery signals in each discovery subframe can be about the same. In an embodiment, the rate of periodic measurements for devices associated with a discovery group may be used by the network as an indication of the number of devices associated with that discovery group.

In another embodiment, the network may decide to create more discovery groups where the device density is higher. For example, if DGBs are selected at random from the population of connected devices, the density of DGBs in a given area is expected to be proportional to the overall density of devices in that vicinity. Thus, on average, each discovery group may consist of approximately the same number of devices. However, in this case the distribution of DGBs loses the uniformity desired to address the first objective of selection of group beacons.

In another embodiment, the network may select the density of DGBs to satisfy both objectives above. For example, the network may select DGBs to be uniformly distributed, as described above, as long as the estimated device density is less than a predefined threshold. If the estimated device density exceeds this threshold, the network can select more densely spaced DGBs in proportion to the local estimation of device density.

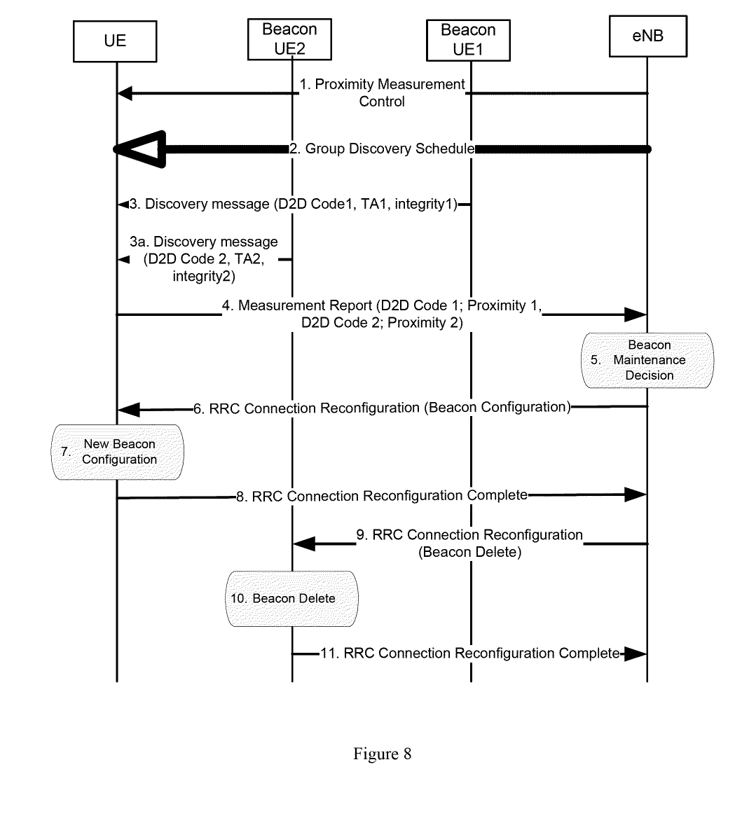

FIG. 8 illustrates an exemplary message flow for group beacon scheduling, discovery, and measurement reporting to the eNB in LTE. At step 1, the eNB sends proximity measurement control information to a UE. At step 2, the UE receives the group discovery schedule from the eNB and proceeds to discover group beacons UE1 and UE2 in steps 3 and 3a, respectively. At step 4, the UE reports its measurements to the eNB. Based on these measurements the eNB decides, in step 5, to configure this UE as a new group beacon replacing beacon UE2. At step 6, the eNB sends a radio resource control (RRC) signal with beacon reconfiguration information to the UE. At step 7, the UE self-reconfigures as a group beacon, and sends, at step 8, a RRC signal to the eNB indicating completion of reconfiguration. At step 9, the eNB sends a RRC connection configuration to UE2 to remove its beacon status. At step 10, UE2 self-reconfigures as a non-beacon and sends, in step 11, a RRC signal to the eNB with this reconfiguration.

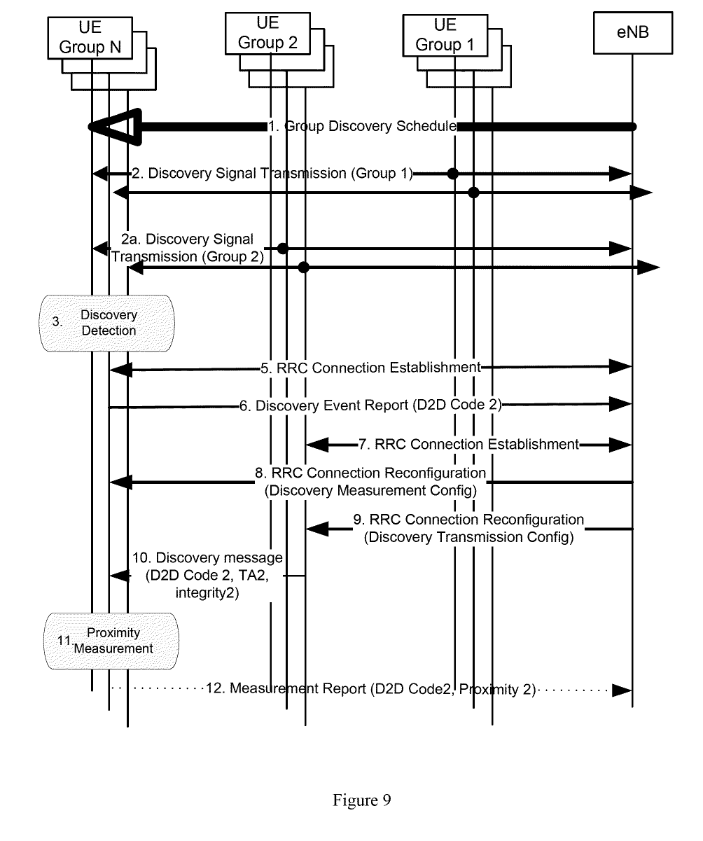

FIG. 9 illustrates an exemplary message flow for the discovery of non-beacon devices in LTE. At step 1, the eNB broadcasts the group discovery schedule for each of several discovery groups. In step 2, devices of discovery group 1 transmit discovery signals in their designated discovery subframe. In step 2a, devices of discovery group 2 transmit discovery signals in their designated discovery subframe. At step 3, a device in group N receives these discovery signals and discovers another device of interest in group 2. The discovering device then connects to the eNB (step 5) and reports the discovery (step 6). The eNB then allocates a dedicated resource for the two devices to confirm that the discovery is correct (steps 7 to 9). The UE in group N then receives a discovery message from the UE in group 2 (step 10), performs proximity measurement accordingly (step 110, and reports the measurement to the eNB (step 12).

Various embodiments may also include additional features. For instance, a group beacon device may receive the discovery signals from other devices belonging to this discovery group. The group beacon may then transmit the totality of all the device identifiers for devices it has discovered belonging to its group to the network or eNB. In another feature, the network may use the information of devices belonging to two discovery groups, and the proximity of the two discovery group beacons to each other, as a first indication of the proximity of two devices belonging to each of the two discovery groups respectively. The network may then direct these two candidate devices to discover each other to confirm their proximity. In yet another feature, the eNB may also receive the discovery signal of devices directly. According to another feature, the eNB may broadcast a list of some or all device identities, which the eNB has discovered or received from group beacon devices, to every device under its coverage. This may help any device in the eNB's coverage to get an indication of the proximity of another device. In another feature, the eNB may receive information about devices under the coverage of adjacent eNBs or the group beacon schedule for group beacon devices served by adjacent eNBs, either directly from an adjacent eNB or via another network entity such as a gateway or server. In one feature, the eNB may broadcast information about the identity of devices under the coverage of an adjacent eNB, or the group beacon schedule for group beacons served by an adjacent eNB to all devices under its coverage. This information may help devices under its coverage to discover other devices under the coverage of an adjacent eNB.

In an alternative embodiment to using group beacons, devices may form groups based on their geographic locations. The network may transmit information about the geographic extent of each discovery group (e.g., the location of a group's center and its radius). A device can detect its location using a Global Positioning System (GPS), for example, and from this information decides which group it should belong to. This approach assumes that each device is equipped with the GPS or other means to detect its location.

Alternatively, any of a number of existing approaches may be used by the network to find the location of a device, and then assign each device to a specific discovery group. However, such approaches would involve significant amount of signaling, which would impact scalability. In addition, such approaches may not be applicable to idle devices.

In another possible embodiment, devices may self-configure as group beacons, without selection by the network. However, the network may be more capable to select appropriate group beacons, since it can collect measurements from different devices and select the best subset to serve as group beacons. In addition, by scheduling the transmission of discovery signals from the group beacons, it is relatively easy for the network to inform non-beacons when to listen for these discovery transmissions, and to prevent potential collisions between discovery signals of different beacons that could occur without the coordination of the network.

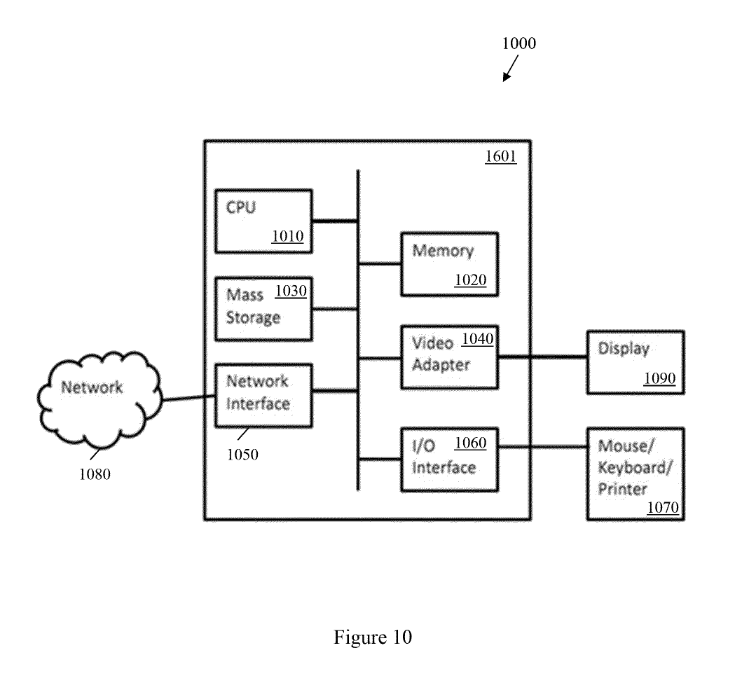

FIG. 10 is a block diagram of a processing system 1000 that can be used to implement various embodiments. For instance the processing system 1000 can be part of a UE or other network devices. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system 1000 may comprise a processing unit 1001 equipped with one or more input/output devices, such as a speaker, microphone, mouse, touchscreen, keypad, keyboard, printer, display, and the like. The processing unit 1001 may include a central processing unit (CPU) 1010, a memory 1020, a mass storage device 1030, a video adapter 1040, and an I/O interface 1060 connected to a bus. The bus may be one or more of any type of several bus architectures including a memory bus or memory controller, a peripheral bus, a video bus, or the like.

The CPU 1010 may comprise any type of electronic data processor. The memory 1020 may comprise any type of system memory such as static random access memory (SRAM), dynamic random access memory (DRAM), synchronous DRAM (SDRAM), read-only memory (ROM), a combination thereof, or the like. In an embodiment, the memory 1020 may include ROM for use at boot-up, and DRAM for program and data storage for use while executing programs. In embodiments, the memory 1020 is non-transitory. The mass storage device 1030 may comprise any type of storage device configured to store data, programs, and other information and to make the data, programs, and other information accessible via the bus. The mass storage device 1030 may comprise, for example, one or more of a solid state drive, hard disk drive, a magnetic disk drive, an optical disk drive, or the like.

The video adapter 1040 and the I/O interface 1060 provide interfaces to couple external input and output devices to the processing unit. As illustrated, examples of input and output devices include a display 1090 coupled to the video adapter 1040 and any combination of mouse/keyboard/printer 1070 coupled to the I/O interface 1060. Other devices may be coupled to the processing unit 1001, and additional or fewer interface cards may be utilized. For example, a serial interface card (not shown) may be used to provide a serial interface for a printer.

The processing unit 1001 also includes one or more network interfaces 1050, which may comprise wired links, such as an Ethernet cable or the like, and/or wireless links to access nodes or one or more networks 1080. The network interface 1050 allows the processing unit 1001 to communicate with remote units via the networks 1080. For example, the network interface 1050 may provide wireless communication via one or more transmitters/transmit antennas and one or more receivers/receive antennas. In an embodiment, the processing unit 1001 is coupled to a local-area network or a wide-area network for data processing and communications with remote devices, such as other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method performed by a network controller for grouping devices for device-to-device (D2D) discovery, the method comprising:
allocating a plurality of transmission opportunities for D2D discovery in a wireless network, each one of the transmission opportunities defining at least one of a time slot and a frequency for transmitting a discovery subframe for D2D discovery;
grouping, via signaling, a plurality of devices in the wireless network into a plurality of groups, the devices in each group of the groups being in close proximity to each other; and
assigning to each group a corresponding transmission opportunity of the allocated transmission opportunities.

2. The method of claim 1, wherein the grouping via signaling includes:
selecting a device to serve as a group beacon device for each group;
assigning for the group beacon device in each group a corresponding group beacon discovery subframe for transmitting a beacon signal by the group beacon device, the group beacon discovery subframe allocated at least one of a second time slot non-overlapping with the time slot of the discovery subframe of the group, and a second frequency non-overlapping with the frequency of the discovery subframe of the group; and
indicating the group beacon device and the corresponding group beacon discovery subframe to the devices of each group.

3. The method of claim 2, wherein the selecting further includes:
receiving signal measurements from at least one of the devices, current group beacons, and other devices within coverage of the wireless network; and
selecting the group beacon device for each group in accordance with the signal measurements.

4. The method of claim 2, wherein the selecting further includes:
detecting the devices within a coverage of the network;
estimating a density of the devices within the coverage of the network; and
selecting the group beacon device for each group in accordance with the density of the devices.

5. The method of claim 2 further comprising instructing, via signaling, the devices to associate with the group beacon device for each group according to signal strength, distance, or other measure of the beacon signal.

6. The method of claim 2 further comprising removing a selected group beacon device upon detecting the selected group beacon device in close proximity, according to a predefined distance threshold, to one or more other selected group beacon devices.

7. The method of claim 6 further comprising selecting a new group beacon device to replace the removed group beacon device.

8. The method of claim 1 further comprising:
scheduling a subset of the devices for each group to transmit the discovery subframe; and
scheduling the remaining devices for the group to listen to other discovery subframes from the other groups of devices.

9. The method of claim 1 further comprising scheduling the devices to transmit the discovery subframe on a plurality of corresponding frequency resources or signatures.

10. The method of claim 1, wherein the assigning a plurality of devices into a plurality of groups, includes assigning a same discovery subframe to substantially distant groups of devices according to a distance threshold.

11. The method of claim 10, wherein, according to the grouping of the devices into the plurality of groups, the devices of a group have about equal path losses to a remote device of another group.

12. A network controller providing device grouping for device-to-device (D2D) discovery, the network controller comprising:
at least one processor; and
a non-transitory computer readable storage medium storing programming for execution by the at least one processor, the programming including instructions to:
allocate a plurality of transmission opportunities for D2D discovery in a wireless network, each one of the transmission opportunities defining at least one of a time slot and a frequency for transmitting a discovery subframe for D2D discovery; and
group, via signaling, a plurality of devices in the wireless network into a plurality of groups, the devices in each group of the groups being in close proximity to each other; and
assign to each group a corresponding transmission opportunity of the allocated transmission opportunities.

13. The network controller of claim 12, wherein the instructions to group via signaling includes further instructions to:
select a device to serve as a group beacon device for each group;
assign to the group beacon device for each group a corresponding group beacon discovery subframe for transmitting a beacon signal by the group beacon device, the group beacon discovery subframe allocated at least one of a second time slot and a second frequency for transmitting a beacon signal by the group beacon device; and
indicate the group beacon device and the corresponding group beacon discovery subframe to the devices of each group.

14. A method performed by a user device for enabling device grouping for device-to-device (D2D) discovery, the method comprising:
receiving, from a network controller, scheduling information for a discovery subframe, the discovery subframe defining at least one of a time slot and a frequency for transmitting a discovery signal;
receiving, from the network controller, an identity of a group beacon device;
receiving, from the network controller, scheduling information for a group beacon discovery subframe, the group beacon discovery subframe defining at least one of a second time slot and a second frequency for transmitting a beacon signal by the group beacon device;
performing one of transmitting and listening to the discovery signal in the discovery subframe according to the scheduling information for the group beacon discovery subframe; and
performing one of transmitting and listening to the beacon signal in the group beacon discovery subframe according to the identity of the group beacon device and the scheduling information for the group beacon discovery subframe.

15. The method of claim 14 further comprising, according to the scheduling information for the discovery subframe, transmitting the discovery signal in the discovery subframe simultaneously with one or more other devices in proximity with the user device.

16. The method of claim 14 further comprising, according to the scheduling information for the discovery subframe, transmitting the discovery signal in the discovery subframe on a corresponding frequency resource or signature allocated exclusively to the user device.

17. The method of claim 14, wherein the user device is not a group beacon device according to the identity, and wherein the method further includes:
receiving the beacon signal from the group beacon device;
performing a signal measurement of the group beacon device; and
reporting, to the network controller, the signal measurement.

18. The method of claim 17 further comprising receiving, in response to reporting the signal measurement, information for configuring the user device as a group beacon device.

19. The method of claim 14, wherein the user device is the group beacon device according to the identity, and wherein the method further includes transmitting the beacon signal in the group beacon discovery subframe.

20. A user device supporting device grouping for device-to-device (D2D) discovery, the user device comprising:
at least one processor; and
a computer readable storage medium storing programming for execution by the at least one processor, the programming including instructions to:
detect, from a network controller, scheduling information for a discovery subframe, the discovery subframe defining at least one of a time slot and a frequency for transmitting a discovery signal;
detect, from the network controller, an identity of a group beacon device;
detect, from the network controller, scheduling information for a group beacon discovery subframe, the group beacon discovery subframe defining at least one of a second time slot and a second frequency for transmitting a beacon signal by the group beacon device;
perform one of transmitting and listening to the discovery signal in the discovery subframe according to the scheduling information for the group beacon discovery subframe; and
perform one of transmitting and listening to the beacon signal in the group beacon discovery subframe according to the identity of the group beacon device and the scheduling information for the group beacon discovery subframe.
